(19) United States
(12) Patent Application Publication
(10) Pub. No.: US 2025/0076863 A1
(43) Pub. Date: Mar. 6, 2025

(54) INTELLIGENT MONITORING, INVERSION AND DYNAMIC PREDICTION SYSTEM FOR TRANSIENT PROCESS OF PUMPED STORAGE UNITS

(71) Applicant: Wuhan University, Wuhan (CN)

(72) Inventors: Zhigao ZHAO, Wuhan (CN); Xiuxing YIN, Wuhan (CN); Fei CHEN, Wuhan (CN); Jiandong YANG, Wuhan (CN)

(21) Appl. No.: 18/644,691

(22) Filed: Apr. 24, 2024

(30) Foreign Application Priority Data
Aug. 31, 2023 (CN) 202311115634.7

(51) Int. Cl. G05B 23/02

(52) U.S. Cl. CPC G05B 23/0229; G05B 23/0243; G05B 23/0272

(57) ABSTRACT

An intelligent monitoring, inversion and prediction system for a transient process of pumped storage units is provided, including: an equipment layer including sensors for obtaining hydraulic, mechanical and electrical operation data of the pumped storage units in real time, a data layer including a real-time database, a relational database, an expert knowledge base and a file system and used for storing hydraulic, mechanical and electrical operation parameters collected by the equipment layer in different levels, a twin layer including a modeling and an application of a digital twin model and used for a three-dimensional modeling and a key information visual display of a pumped storage system with BIM technology and a service layer displaying one-dimensional time domain parameters and designing and visualizing front-end interfaces for six functions: operation optimization, online monitoring, inversion, dynamic prediction, health assessment and fault warning.

### CROSS-REFERENCE TO RELATED APPLICATIONS

This application claims priority to Chinese Patent Application No. 202311115634.7, filed on Aug. 31, 2023, the contents of which are hereby incorporated by reference.

### TECHNICAL FIELD

The disclosure belongs to a field of operation and maintenance of pumped storage power stations, and in particular to an intelligent monitoring, inversion and prediction system for a transient process of pumped storage units.

### BACKGROUND

In terms of unit performance evaluation and health assessment, many mature intelligent systems have been applied in the condition monitoring technology of hydropower plants, such as the Vibrocontrol4000 system of Schenck Process GmbH, the VM600 system of VIBRO-METER Company (Switzerland), and the turbine cavitation supervision system jointly developed by research institutions in the United States and Canada. The research on the condition supervision system of hydropower units in China started late. Since 1990s, the NW6231 monitoring and analysis system of hydropower units has been developed by Institute of Hydroelectric and Power Research of the Ministry of Water and Electricity, Nanjing Institute of Technology and Nanjing Wireless Instrument Factory for on-line monitoring of unit vibration. A number of universities in China, represented by Huazhong University of Science and Technology, have also conducted a series of studies on the condition monitoring of hydropower units. However, the above systems all have some shortcomings, such as scattered functions, redundancy and single evaluation method.

In the aspect of fault warning and inversion, fault diagnosis methods based on fault tree theory and expert system have been widely studied, and emerging information technologies such as neural network, swarm intelligence optimization, artificial intelligence and machine learning have been gradually introduced into the fault warning of the hydropower units, which has positive significance for improving the operation and maintenance level of the hydropower units. However, the models used in the above technologies are all data-driven models, lacking the support of the operation mechanism of the pumped storage units and are difficult to adapt to the fault warning and inversion analysis of the whole life cycle of the units.

Combined with the research survey at home and abroad, the existing research has following limitations: 1) At present, the application of Digital Twin in the field of pumped storage operation and maintenance has not been seen, and the contradiction and coordination between simulation accuracy and real-time calculation in the twin model is a technical bottleneck to be broken through urgently; 2) Due to the problem of decentralized functions, there are many existing isolated systems, and it is difficult to integrate them into the whole hydropower plant supervision system. The information sharing is poor and the resource utilization rate is low, thus not only causing a large workload of system maintenance in the later period, but also a lot of repetitive and redundant work, which reduces the economy of the whole system operation; 3) The research on the transient process of pumped storage units is mostly concentrated in the design and commissioning stage, and the importance of the transient process is often underestimated in the operation and maintenance stage, and the working condition data of the transient process of units are usually difficult to be completely saved, and the function of inversion and dynamic prediction is not available; 4) The operation accidents of pumping and storage power stations usually occur in the transient process, but at present, the power stations lack corresponding monitoring or forecasting systems, and some key fault operation data are often missing, which is not conducive to the inversion analysis of accidents. Moreover, the evolution of the life cycle of pumped storage power station is a process of state deterioration, and the conventional operation and maintenance mode of after-the-fact maintenance and regular maintenance is not conducive to the safe and efficient operation of the units.

### SUMMARY

In view of the technical problems existing in the background, an intelligent monitoring, inversion and prediction system for a transient process of pumped storage units provided by the disclosure adopts a dual-drive mode of model driven and data driven to realize functions of inversion, transient process prediction anytime and self-learning of digital twin model of pumped storage units.

In order to solve above technical problems, the present disclosure adopts a following technical scheme.

The intelligent monitoring, inversion and prediction system for the transient process of pumped storage units includes an equipment layer, a data layer, a twin layer and a service layer; the equipment layer includes sensors for obtaining hydraulic, mechanical and electrical operation data of the pumped storage units in real time, where the sensors are interconnected with data acquisition instruments by signal lines; the data layer includes a real-time database, a relational database, an expert knowledge base and a file system, the data layer is used for storing hydraulic, mechanical and electrical operation parameters collected by the equipment layer in different types; the twin layer adopts a dual-drive mode of model driven and data driven, a twin unit as a core has a function of inversion with a physical unit and an ability to correct and update model parameters. The digital twin model takes the measured parameters from the data layer as the model input, and solves the output values such as rotational speed and power in real time, and outputs them to the physical control equipment through the signal lines, which constitutes the closed-loop control; the service layer is used for a visual display of key information of a pumped storage system with Building Information Modeling (BIM) technology; the service layer displays time-domain parameters of transient process based on predicted and measured operation data of the digital twin model, and designs and visualizes front-end interfaces for six functions: operation optimization, online monitoring, inversion, dynamic prediction, health assessment and fault warning.

Optionally, the equipment layer also includes data acquisition instruments, a data switch, a command console, an intelligent system terminal and a data server; where the data acquisition instruments include an mechanical data acquisition instrument, an electrical system data acquisition instrument and a hydraulic data acquisition instrument; the intelligent system terminal is electrically connected with the mechanical data acquisition instrument, the electrical system data acquisition instrument and the hydraulic data acquisition instrument through the data switch; the intelligent system terminal is electrically connected with a remote end of the command console through the command console; the data server is deployed on the intelligent system terminal; the data server is electrically connected with a supervision system; the supervision system is electrically connected with the command console and a monitoring remote end respectively.

Optionally, the sensors include water hammer pressure sensors, pressure pulsation sensors, differential pressure sensors, electromagnetic flowmeter, a main servomotor travel sensor, a ball valve servomotor travel sensor, a shaft torque sensor of pump turbine, speed sensor, vibration sensors of pump turbine, spindle swing sensor of shafting, vibration sensor of the ball valve and a vibration sensor of penstock.

Optionally, the command console has two functions: a commissioning condition instruction and a normal operation condition instruction, and the command console and the supervision system are in two-way communication.

Optionally, the supervision system triggers the command console to send an acquisition instruction to the data acquisition instruments, and forms an independent data packet for each transient process, so as to provide measurement dataset for operation optimization, online monitoring, inversion, dynamic prediction, health assessment and fault warning of transient process; the monitoring system triggers the command console to send an acquisition instruction to a data acquisition system while giving an instruction to operate related control equipment.

Optionally, an instruction for the data acquisition system to stop an acquisition is issued by the command console at the same time as a start instruction according to a working condition nature of the transient process, or the data acquisition instruments automatically judge fluctuations of various physical quantities, sets corresponding sampling time, and automatically stops the acquisition.

Optionally, the data servers includes a data processing server and a WEB server, where the data processing server is used for receiving data of the data acquisition system, processing and storing the data; the WEB server is used for running an online information of publishing service; the data server is used for connecting with the command console to issue instructions to each data acquisition instrument, and for summarizing collected data to form working condition data packets.

Optionally, the data layer includes a processing and mining module, where the processing and mining module is used for data cleaning, data analysis and data mining.

Optionally, the twin layer includes a digital twin module, the digital twin module is used for constructing the digital twin model of the pumped storage units and developing the digital twin function; the function of the digital twin model is to predict the dynamic parameters of the transient process in the future 600 s based on the current measurement data from the data layer.

Optionally, the service layer includes a health assessment module, a fault warning module and a front-end visualization module; where the health assessment module evaluates the health state of pumped storage unit by using a fuzzy analytic hierarchy process based on real-time operation data; the health assessment module can evaluate a potential accident process of the unit based on prediction data of the transient process, analyzes advantages and disadvantages of the transient process; the health assessment module also can evaluate the dynamic performance under various operation strategies under commissioning and maintenance conditions, and then optimize the best operation strategy based on the dynamic prediction; the fault warning module adopts a fault tree theory or an expert semantic network to establish a set of targeted fault diagnosis knowledge base, and locates the fault type and reason according to operation data; the fault warning module is used for giving an early warning when the dynamic indicators exceed the standard in the dynamic prediction of transient process under extreme conditions, and an early warning signal is issued when the health assessment value is lower than the limit value under normal operating conditions; where the front-end visualization module directly presents the equipment of the pumped storage system based on the three-dimensional visualization technology, marks the positions of the measuring points of the sensors, and displays the operation data in real time.

The disclosure has following beneficial effects:
1) The digital twin model based on the whole life cycle of the pumped storage unit provided by the disclosure adopts a dual-drive mode of model driven and data driven to realize functions of operation optimization, online monitoring, inversion, dynamic prediction, health assessment and fault warning;
2) The novel technology of health assessment and fault warning based on the transient process helps the pumped storage unit to upgrade from empirical operation and maintenance to intelligent operation and maintenance;
3) The key technologies of multi-source heterogeneous state monitoring and massive operation data mining of hydraulic-mechanical-electrical coupling system provide technical support for distributed data acquisition, data analysis and data mining of pumped storage stations;
4) This invention can predict the transient process of 600 s in the future and realize the fault early warning under extreme conditions; it can monitor and evaluate the operating performance, grasp the health status of the unit in real time, and avoid unplanned outages; it also has the inversion function to optimize the operation strategy of the unit, including setting the control parameters, optimizing the opening and closing law. It provides a basic guiding tool for the safe and stable operation of pumped storage system.

### BRIEF DESCRIPTION OF THE DRAWINGS

The present disclosure is further described with reference to attached drawings and embodiments:

FIG. 1 is a system architecture diagram of the present disclosure.

FIG. 2 is a signal-flow chart of the present disclosure.

FIG. 3 is the display interface of a frequency analysis of the present disclosure.

FIG. 4A is the comparison diagram of the volute pressure between predicted results by the digital twin model and measurement.

FIG. 4B is the comparison diagram of the pressure at the draft tube between predicted results by the digital twin model and measurement.

FIG. 4C is the comparison diagram of the rotational speed between predicted results by the digital twin model and measurement.

FIG. 4D is the comparison diagram of the active power between predicted results by the digital twin model and measurement.

FIG. 4E is the comparison diagram of the discharge between predicted results by the digital twin model and measurement.

FIG. 4F is the comparison diagram of the stator current between predicted results by the digital twin model and measurement.

FIG. 5 is dynamic prediction of the present disclosure.

FIG. 6 is the time-frequency analysis of the signals in the present disclosure.

FIG. 7 is online monitoring interface of the present disclosure.

FIG. 8 is an interface for auxiliary functions such as data export and report printing according to the present disclosure.

FIG. 9 is the three-dimensional visualization and fault warning interface of the present disclosure.

FIG. 10 is the health assessment interface of the present disclosure.

### Interface Description.

WADAI: Data acquisition instrument of hydraulic subsystem
ESDAI: Data acquisition instrument of electrical subsystem
UDAI: Data acquisition instrument of mechanical subsystem
SLGB: Swing of lower guide bearing
RASA: Relative amplitude spectrum analysis
MSP: Maximum spectral peak
LSC: Linear scale coordinate
VVC: Vernier vertical coordinate
VHC: Vernier horizontal coordinate
SUGB: Top cover vibration
ASA: Amplitude spectrum analysis
UW: Unanalyzed waveform
T-DI: Time-domain indicators
SA: Spectral analysis
OSC: Orbit of shaft center
CA: Correlation analysis
WD: Wavelet decomposition

### DETAILED DESCRIPTION OF THE EMBODIMENTS

### Embodiment 1

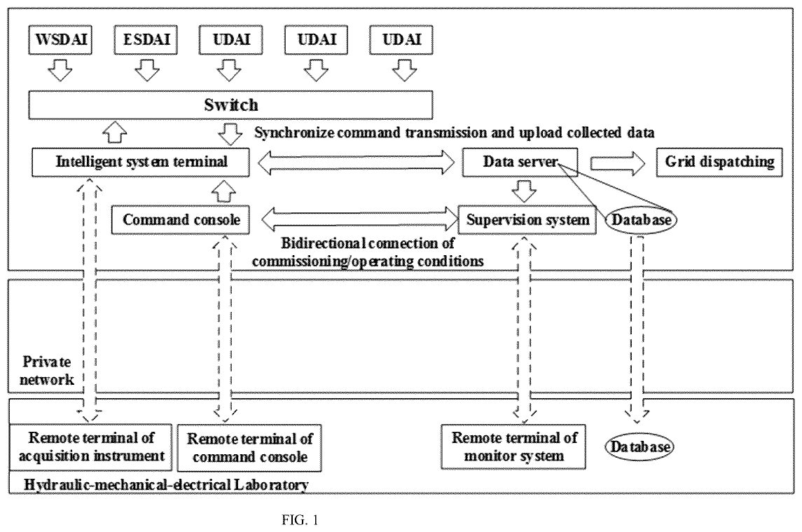

The disclosure aims to measure the time-history change of each physical quantity in the transient process of an unit from an initial stable working condition to another end stable working condition, so as to meet requirements of inversion analysis and early warning analysis of debugging/normal operation, and to make scheduling decision and control by a supervision system of a pow supply station and a power grid. As shown in FIG. 1, the system framework is divided into four layers from bottom to top: an equipment layer, a data layer, a twin layer and a service layer, has six functions: operation optimization, online monitoring, inversion, dynamic prediction, health assessment and fault warning. It provides online and offline modes: 1) online mode: interconnected with the unit, online monitoring the operation data of the physical unit for health assessment; interconnected with control equipment to form a closed-loop real-time control for setting and optimizing control parameters or strategies; 2) off-line mode: used for predicting the transient process of extreme working conditions based on a real-time running state, and used for updating model parameters, driven by running data, and the model parameters evolve with the life cycle of the unit. Based on the whole life cycle of pumped storage units, the system focuses on the key issues of safe, stable and efficient operation of units, and has following effects when applied to pumped storage power stations: 1) Ensuring the safety of units: predicting the transient process of extreme working conditions of power stations around the clock and realizing safety early warning; 2) Improving the equipment utilization rate: carrying out condition monitoring and health assessment to avoid unplanned outage; 3) Prolonging the service life of the unit: analyzing the deterioration trend and warning the faults to reduce the early fault operation of the unit; 4) Optimizing the unit operation strategy: setting control parameters, optimizing opening and closing laws and guiding the operation of pumping and storage units. The specific scheme is as follows:

The optional scheme is shown in FIGS. 1-10. An intelligent monitoring, inversion and prediction system for a transient process of pumped storage units includes an equipment layer, a data layer, a twin layer and a service layer; the equipment layer includes sensors for obtaining hydraulic, mechanical and electrical operation data of the pumped storage units in real time, where the sensors are interconnected with data acquisition instruments by signal lines; the data layer includes a real-time database, a relational database, an expert knowledge base and a file system, the data layer is used for storing hydraulic, mechanical and electrical operation parameters collected by the equipment layer in different types; the twin layer adopts a dual-drive mode of model driven and data driven, a twin unit as a core has a function of inversion with a physical unit, and an ability to correct and update model parameters; The digital twin model takes the measured parameters from the data layer as the model input, and solves the output values such as rotational speed and power in real time, and outputs them to the physical control equipment through the signal lines, which constitutes the closed-loop control; the service layer is used for a visual display of key information of a pumped storage system with Building Information Modeling (BIM) technology; the service layer displays time-domain parameters of transient process based on predicted and measured operation data of the digital twin model, and designs and visualizes front-end interfaces for six functions: operation optimization, online monitoring, inversion, dynamic prediction, health assessment and fault warning.

At the equipment layer, the system obtains hydraulic, mechanical and electrical operation data of the pumped storage units in real time through various sensors, where the sensors are interconnected with data acquisition instruments by signal lines; the data layer includes a real-time database, a relational database, an expert knowledge base and a file system, the data layer is used for storing hydraulic, mechanical and electrical operation parameters collected by the equipment layer in different types; the twin layer adopts a dual-drive mode of model driven and data driven, a twin unit as a core has a function of inversion with a physical unit and an ability to correct and update model parameters. The digital twin model takes the measured parameters from the data layer as the model input, and solves the output values such as rotational speed and power in real time, and outputs them to the physical control equipment through the signal lines, which constitutes the closed-loop control; the service layer is used for a visual display of key information of a pumped storage system with Building Information Modeling (BIM) technology; the service layer displays time-domain parameters of transient process based on predicted and measured operation data of the digital twin model, and designs and visualizes front-end interfaces for six functions: operation optimization, online monitoring, inversion, dynamic prediction, health assessment and fault warning.

The schematic diagram of the application of the system in the experimental platform of dynamic characteristics of pumped storage units is shown in FIG. 1, online and offline modes are provided: 1) online mode: interconnected with the unit, online monitoring the operation data of the physical unit for health assessment; interconnected with control equipment to form a closed-loop real-time control for setting and optimizing control parameters or strategies; 2) off-line mode: used for predicting the transient process of extreme working conditions based on a real-time running state, and used for updating model parameters, driven by running data, and the model parameters evolve with the life cycle of the unit. The intelligent monitoring, inversion and prediction system for the transient process of pumped storage units may measure the time-history change of each physical quantity in the transient process of an unit from an initial stable working condition to another end stable working condition, so as to meet requirements of inversion analysis and early warning analysis of debugging/normal operation, and to make scheduling decision and control by a supervision system of a pow supply station and a power grid.

Further, the equipment layer also includes data acquisition instruments, a data switch, a command console, an intelligent system terminal and a data server; where the data acquisition instruments include an mechanical data acquisition instrument, an electrical system data acquisition instrument and a hydraulic data acquisition instrument; the intelligent system terminal is electrically connected with the mechanical data acquisition instrument, the electrical system data acquisition instrument and the hydraulic data acquisition instrument through the data switch; the intelligent system terminal is electrically connected with a remote end of the command console through the command console; the data server is deployed on the intelligent system terminal; the data server is electrically connected with a supervision system; the supervision system is electrically connected with the command console and a monitoring remote end respectively. The sensors include water hammer pressure sensors, pressure pulsation sensors, differential pressure sensors, electromagnetic flowmeter, a main servomotor travel sensor, a ball valve servomotor travel sensor, a shaft torque sensor of pump turbine, speed sensor, vibration sensors of pump turbine, spindle swing sensor of shafting, vibration sensor of the ball valve and a vibration sensor of penstock.

The unit data acquisition instrument is equipped with 64 analog channels, 16 switching channels (8 inputs and 8 outputs) and 2 frequency measuring channels, with the highest sampling frequency of 3 kHz and 16 bit of A/D. The hardware is integrated and assembled. The sensors corresponding to the 64 analog channels are distributed as follows:

18 channels for measuring hydraulic parameters:

\textcircled{1} The water hammer pressure sensor includes four measuring points: a volute inlet, a volute end, a draft tube inlet and a draft tube outlet, with a sampling frequency of 500 Hz and a measuring range is 0-1.5 Pₘₐₓ Pa (Pₘₐₓ refers to a calculated extreme value of unit transient process).

\textcircled{2} The pressure pulsation sensor includes 12 measuring points: a ball valve front section, a ball valve rear section, the volute inlet, a vaneless area, a runner seal, a runner and drain ring, a draft tube straight cone inlet, a draft tube elbow inlet, a draft tube outlet, a spindle hydrostatic bearing, a top cover and a lower labyrinth ring, with a sampling frequency of 3 kHz and a measuring range of 0-1.5 Aₘₐₓ Pa (Aₘₐₓ refers to a calculated extreme value of pressure pulsation of unit transient process).

\textcircled{3} The differential pressure sensor includes 2 measuring points: the volute and a 45° section of the draft tube, with a sampling frequency of 1 kHz.

\textcircled{4} The electromagnetic flowmeter or the ultrasonic flowmeter includes 1 measuring point: a pressure branch pipe, with a measuring range of 0-1.5 Qₘₐₓ m³/s (Qₘₐₓ refers to the calculated extreme value of the unit transient process).

There are 29 analog input channels and 1 frequency measurement channel for measuring mechanical parameters.

\textcircled{1} The main servomotor travel sensor includes 1 measuring point, with a sampling frequency of 500 Hz and a measuring range of 0-Sₘₐₓ mm (Sₘₐₓ is servomotor stroke corresponding to a maximum mechanical opening \acute{α}ₘₐₓ of a guide vane).

\textcircled{2} The ball valve servomotor travel sensor includes 1 measuring point, with a sampling frequency of 1 kHz and a measuring range of 0-1.2 Lₘₐₓ mm (Lₘₐₓ is servomotor stroke corresponding to the ball valve in fully open position).

\textcircled{3} The hydraulic turbine shaft torque sensor includes 1 measuring point, with a sampling frequency of 500 Hz and a measuring range of 0-1.3 Mr Nm (Mr is a rated torque of the hydraulic turbine).

\textcircled{4} The unit speed sensor includes 2 measuring points, where one uses the analog channel (toothed disc frequency measurement), and the other uses the frequency measurement channel (residual pressure). A sampling frequency is 1 kHz, and a measuring range is 0-1.2 nₘₐₓr/min (nₘₐₓ refers to the calculated extreme value of the unit transient process).

\textcircled{5} The unit vibration sensor includes 12 measuring points arranged at an upper frame (X, Y, Z directions), a stator frame (X, Y, Z directions), a lower frame (X, Y, Z directions) and a top cover (X, Y, Z directions), and the sampling frequency is 1 kHz.

\textcircled{6} The spindle swing sensor includes 6 measuring points arranged at an upper guide bearing (X, Y directions), a lower guide bearing (X, Y directions) and a water guide bearing (X, Y directions), and the sampling frequency is 1 kHz.

\textcircled{7} The ball valve vibration sensor includes 3 measuring points arranged at the ball valve (X, Y, Z directions), and the sampling frequency is 1 kHz.

\textcircled{8} The vibration sensor of penstock includes 3 measuring points arranged at the exposed steel penstock (X, Y and Z directions), and the sampling frequency is 1 kHz.

Further, the electrical system data acquisition instrument is equipped with 64 analog channels, 16 switching channels (8 in and 8 out) and 2 frequency measuring channels, with the highest sampling frequency of 3 kHz and 16 bit of A/D bits. The hardware is integrated and assembled. The sensors corresponding to the 64 analog channels are distributed as follows:

12 channels for measuring electrical parameters of generator motor:
\textcircled{1} unit voltage sensors: three (A, B and C phases) are led out from a unit-side voltage transformer;
\textcircled{2} unit current sensors: three (A, B and C phases) are led out from the unit-side current transformer;
\textcircled{3} an active power sensor: 1 in number;
\textcircled{4} a reactive power sensors: 1 in number;
\textcircled{5} air gap sensors: 2 in number; and
\textcircled{6} sensors of electromagnetic unbalance force: 2 in number.

Channels for measuring electrical main wiring parameters:
\textcircled{1} a power grid voltage sensor: led out from a power grid-side voltage transformer (phase A, B and C);
\textcircled{2} a power grid current sensor: led out from the power grid-side current transformer (phase A, B and C);
\textcircled{3} switch signals of circuit breakers and contactors in a low-voltage distribution cabinet; and
\textcircled{4} redundant channels are used for backup.

Further, the waterway data acquisition instrument is equipped with 64 analog channels, the hard wiring mode is still used, and the sampling objects are mainly hydraulic parameters and wind parameters, so the sampling frequencies are low: 500 Hz. The sensors corresponding to 64 analog channels are distributed as follows:
water level sensors are arranged at an upstream water inlet, a downstream water outlet, a surge chamber, a gate well, air vents, etc.
pressure sensors are arranged in tunnels, pipes, culverts, open channels, etc. along the route; and
wind speed sensors are arranged in ventilation corridors, ventilation holes, traffic holes, etc.

The water conveyance system layout of pumped storage power stations is very different, so it is necessary to set the number of various sensors according to the specific layout, and determine the range of sensors according to the calculation results of transient process.

The data exchange adopts Cisco Nexus 5000, connects the intelligent monitoring, inversion and prediction system with each data acquisition instrument, transmits instructions synchronously and uploads the acquired data synchronously. Cisco Nexus 5000 series has characteristics of low latency, front and rear ventilation and rear panel port, and is suitable for data centers being about to migrate to 10 Gigabit Ethernet, and arrays ready for unified deployment, so as to support local area networks, storage local area networks and server clusters networked through a single link (or adopt dual links to achieve redundancy).

Further, the command console has two functions: a debugging and operation condition instruction and a normal operation condition instruction, and the command console and the supervision system are in bidirectional communication. The command console has two functions: the debugging and operation condition instruction and the normal operation condition instruction, and the command console is in bidirectional communication with the supervision system and in unidirectional communication with the distributed acquisition instrument. The commissioning operation test conditions may be divided into a normal switching condition, an accident condition (accidents outside the unit), an emergency accident condition (accidents of the unit), a multiple accident condition (superposition of two or more accidents), etc. For the pumped storage power stations, the common commissioning operation test conditions are as follows:
1) start-up and grid-connected power generation (the normal switching condition is divided into three different start-up control modes: open loop, closed loop and open loop+closed loop);
2) load increase under power generation conditions (the normal switching condition is divided into three different control modes: frequency adjustment, power adjustment and opening adjustment);
3) load reduction under the power generation conditions (the normal switching condition is divided into three different control modes: frequency adjustment, power adjustment and opening adjustment);
4) power generation shutdown (the normal switching condition, no load, off the grid, and the opening is closed to zero);
5) load rejection to no-load under the power generation conditions;
6) load rejection to shutdown −1 under the generation conditions (the guide vanes close to zero by the maximum speed);
7) load rejection to shutdown −2 under the generation conditions (the guide vanes and ball valve close together to zero according to the preset rule);
8) load rejection under the generation conditions, guide vane refusing to move, and ball valve closing (in a multiple accident condition, the ball valve closes according to the closing law set in advance, leaving runaway, and the final opening of the ball valve is zero);
9) load rejection under the power generation conditions, guide vane refusing to move and ball valve refusing to move (the multiple accident condition and a runaway condition, may only be realized in the laboratory, and field commissioning is absolutely not allowed);
10) starting mode of pumping (the normal switching condition is divided into three different startup modes: first opening the ball valve and then opening the guide vane, first opening the guide vane and then opening the ball valve, and simultaneously opening the ball valve and guide vane);
11) increased opening of the pump operating condition (the normal switching operating condition, an opening adjustment mode);
12) reduced opening of the pump operating condition (the normal switching working condition, the opening adjustment mode);
13) shutdown of the pump operating condition (the normal switch working condition, with the opening closed to zero and power off);
14) pumped outage condition (the accident condition is divided into three different control modes: guide vane closing, ball valve closing and linkage closing of the guide vane and the ball valve);
15) pumped outage condition, the guide vane refuses to move, and the ball valve is closed (the multiple accident condition, the ball valve is closed according to the closing law set in advance, and is separated from the runaway, and the final opening of the ball valve is zero);
16) pumped outage condition, the guide vane refuses to move, and the ball valve refuses to move (the multiple accident condition and a runaway condition, may only be realized in the laboratory, and field debugging is absolutely not allowed);
For the above 27 working conditions or more, the command console may communicate with the supervision system by direct connection with the local control unit terminal, or by network cable. The former has too many connections, which is inconvenient; the programming of the latter console is a little more complicated. However, no matter which communication mode is adopted, the supervision system needs to identify the instructions sent by the command console. After the supervision system recognizes the working condition switching instruction, it operates the relevant equipment to complete the task. The normal switching condition and the accident condition are usually operated by governor, excitation device, synchronization device, protection device, circuit breaker, oil switch and other equipment; the emergency working condition is operated by emergency pressure distribution valve, protective device, circuit breaker, oil switch and other equipment; and the multiple accident condition is operated by main valve, quick gate, protective device, circuit breaker, oil switch and other equipment.

The instruction of the data acquisition instrument to stop acquisition may be issued by the command console (set in advance or issued at any time) or by the data acquisition instrument itself in advance, but no matter which way is adopted, the longest sampling time Tₘₐₓ needs to be determined according to results of the simulation calculation of the transient process.

In the normal operating condition of the pumped storage units, When external conditions (load change—the unit participates in primary frequency modulation, participates in secondary frequency modulation under grid dispatching/AGC, unit start or stop, accident load rejection outside the unit, etc.) or accident load rejection of the unit itself, the supervision system automatically identifies the information such as circuit breaker, oil switch, grid frequency, machine frequency and load, and operates related control equipment to stabilize an initial condition safely and smoothly. AGC frequency modulation, unit startup or shutdown are preset by power grid dispatching, while other working conditions happen by accident.

In order to avoid the continuous massive data acquisition and storage by the data acquisition instrument, the supervision system is used to trigger the command console to send acquisition instructions to the data acquisition instrument, and an independent data packet is formed for each transient process for actual measurement, inversion analysis and early warning.

When the supervision system issues instructions to operate the relevant control equipment, it triggers the command desk to issue acquisition instructions to the data acquisition system. The supervision system operates one or multiple control equipment according to different transient process conditions. For the pumped storage power stations, the common transient process conditions in normal operation are as follows:
1) start-up and grid-connected power generation (the normal switching condition is divided into three different start-up control modes: open loop, closed loop and open loop+closed loop);
2) load increase under power generation conditions (the normal switching condition is divided into three different control modes: frequency adjustment, power adjustment and opening adjustment);
3) load reduction under the power generation conditions (the normal switching condition is divided into three different control modes: frequency adjustment, power adjustment and opening adjustment);
4) power generation shutdown (the normal switching condition, no load, off the grid, and the opening is closed to zero);
5) load rejection to no-load under the power generation conditions (the accident condition is divided into two different control modes: frequency regulation, frequency regulation+speed increase protection);
6) load rejection to shutdown −1 under the power generation conditions (the emergency condition is completed by the emergency pressure distribution valve operating the relay according to the preset closing law, and the final opening is zero);
7) load rejection to shutdown −2 under the generation conditions (in an emergency condition, respective relays are operated according to the linkage closing law of an emergency pressure distribution valve and the ball valve preset in advance, and the final opening is zero);
8) load rejection under the power generation conditions, guide vane refusing to move, and ball valve closing (in a multiple accident condition, the ball valve closes according to the closing law set in advance, leaving runaway, and the final opening of the ball valve is zero);
9) water pump startup (the normal switching condition is divided into three different startup modes: first opening the ball valve and then opening the guide vane, first opening the guide vane and then opening the ball valve, and simultaneously opening the ball valve and guide vane);
10) increased opening of the pump operating condition (the normal switching operating condition, an opening adjustment mode);
11) reduced opening of the pump operating condition (the normal switching working condition, the opening adjustment mode);
12) shutdown of the pump operating condition (the normal switch working condition, with the opening closed to zero and power off);
13) power failure of the water pump (the accident condition is divided into three different control modes: guide vane closing, ball valve closing and linkage closing of the guide vane and the ball valve);
14) the water pump is powered off, the guide vane refuses to move, and the ball valve is closed (the multiple accident condition, the ball valve is closed according to the closing law set in advance, and is separated from the runaway, and the final opening of the ball valve is zero);
there are 25 working conditions, compared with the commissioning operation conditions, which are basically consistent. Triggering the command console to send out the acquisition start signal is a transient process that does not need to identify what causes and what working conditions are caused, and is simpler compared with the reverse of debugging and operation. However, if the independent data packet formed in each transient process is named automatically and accurately, the supervision system itself needs to identify the corresponding working condition, and send the name, occurrence time, processing mode and other information of the working condition to the command console, and the command console transfers them to the data acquisition system.

An instruction of the data acquisition instrument to stop acquisition: The instruction for the data acquisition system to stop acquisition may be issued by the command console at the same time as the start instruction (delayed in advance or issued at any time) according to the working conditions of the transient process, or the data acquisition instrument may automatically judge the fluctuation of various physical quantities, set the corresponding bandwidth and automatically stop acquisition.

Further, the intelligent monitoring, inversion and prediction system is deployed on the data server, which not only has the function of giving instructions to each data acquisition instrument connected with the command console, but also has functions of preprocessing, data display and data processing, and simultaneously stores the data packets in the data server;

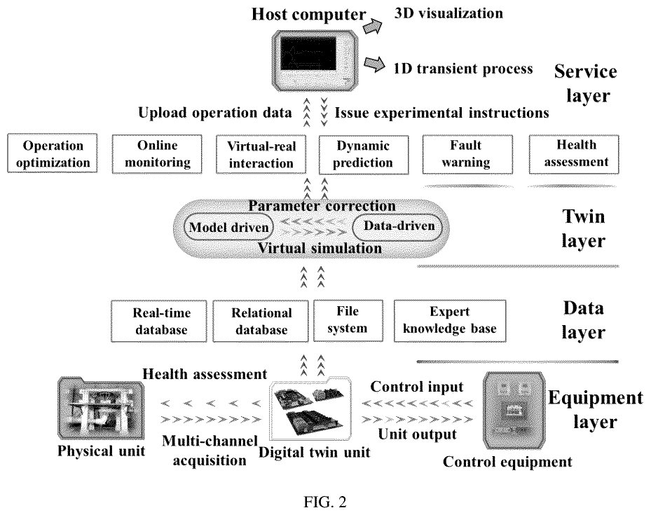

Further, the data server includes a data receiving server, a data processing server and a WEB server, where the data receiving server is used for receiving data of the acquisition system, the data processing server is used for storing and processing the data, and the WEB server is used for running an online information publishing service; As shown in FIG. 2, the data server has a function of one-way communication with the supervision system and power grid dispatching, that is, the function of receiving data or releasing information; the intelligent monitoring, inversion and prediction system terminal has the function of two-way communication with the digital server. The system terminal may not only obtain the unit operation data from the data server for visual display, health assessment and fault warning, but also transmit the prediction results of the digital twin model to the data server for storage.

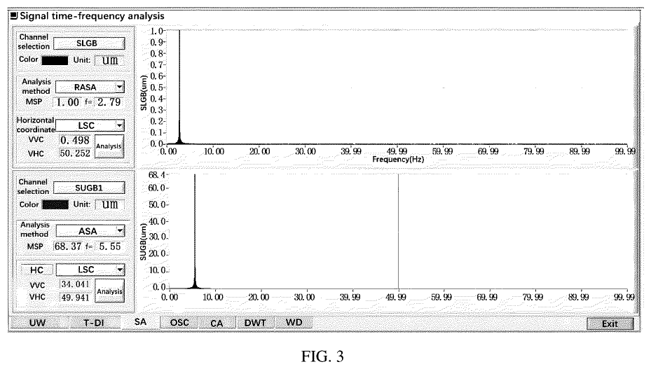

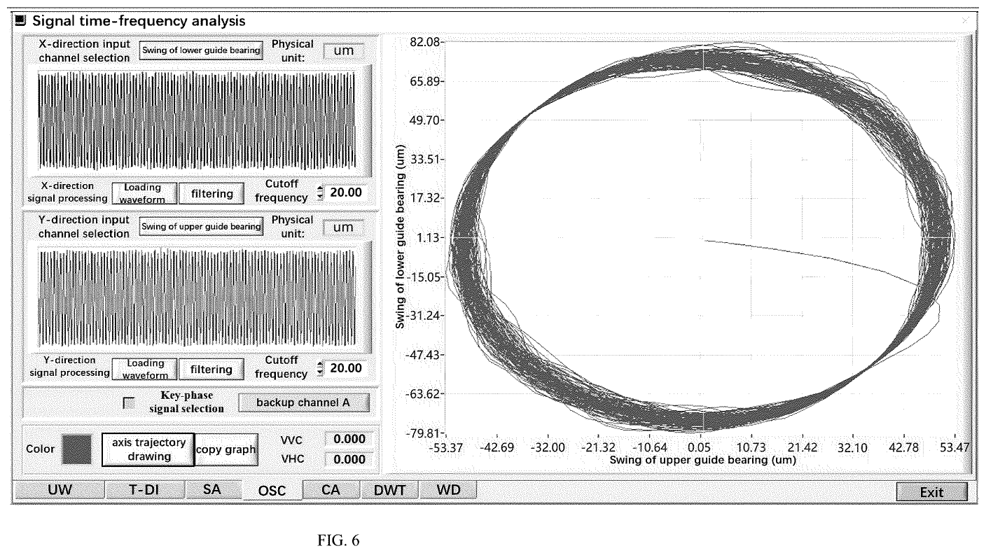

Further, the data processing and mining module includes three functions: data cleaning, data analysis and data mining:
1) the data cleaning function: for normal operation data, storing the normal operation data in seconds, and the normal operation data is automatically overwritten when the storage time reaches a set time limit; for transient process data, increasing the sampling frequency according to a working condition judgment instruction of the command console, and forming and storing an independent data packet in the data layer real-time database;
2) the data analysis function: adopting a time-frequency domain analysis method (as shown in FIG. 3) and sending to the service layer for rich function development (as shown in FIG. 6), and using as the data source for real machine health assessment;
3) the data mining function: sending the data packets of the transient process to the twin layer as a data-driven source to correct and update the parameters of the twin model.

Further, the digital twin module includes a digital twin model construction and a digital twin function development of the pumped storage units, and the digital twin model adopts a dual-drive mode of model driven and data driven:
1) model driven: based on the transient process simulation software TOPSYS developed by Wuhan University, the pipeline system model adopts the method of characteristic, the pump-turbine model adopts the spatial surface interpolation method, and the generator-motor adopts the high-order model;
2) data driven: the real-time running data is input as the initial working condition of the twin model, and is used for predicting the untimely transient process; the independent data packet of the transient process is the training data of the twin model, and is used for the self-learning of the twin model and the correction and update of the model parameters.

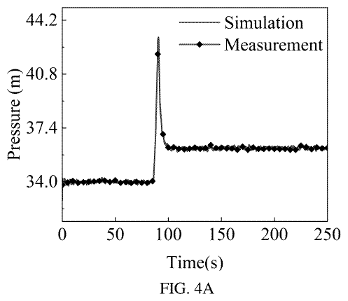

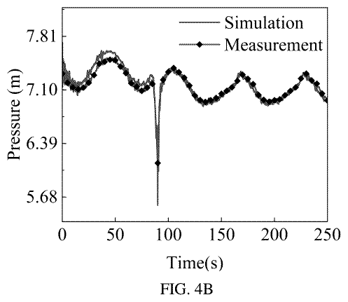

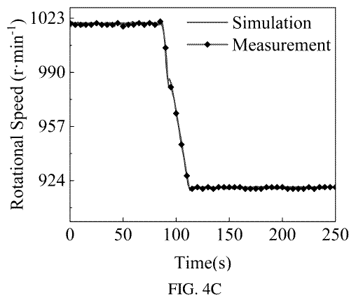

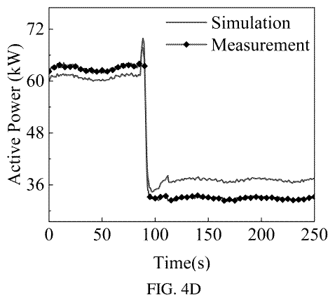

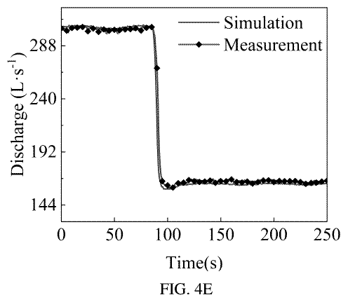

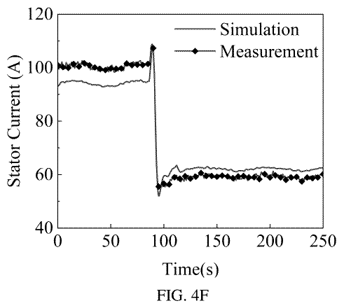

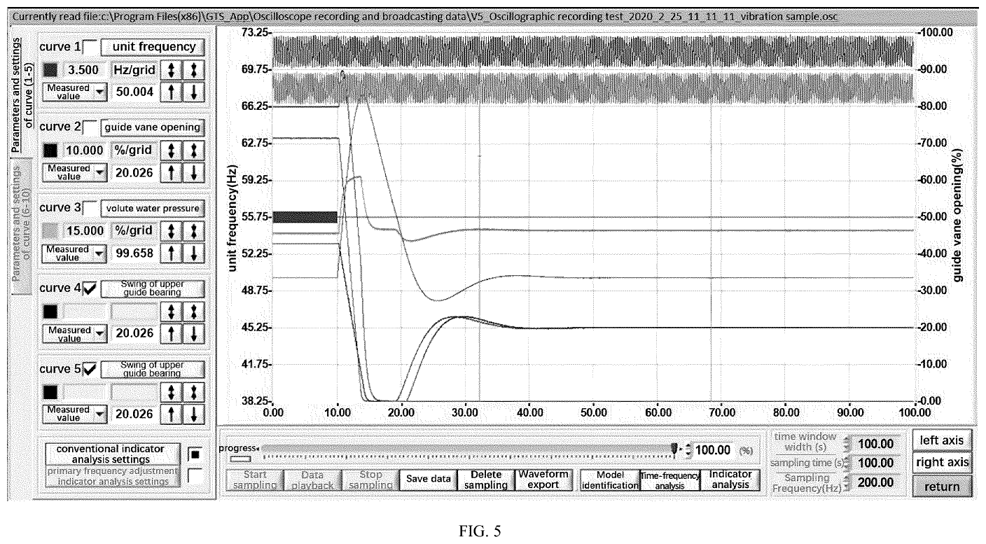

The dynamic prediction results are shown in FIG. 5. The comparison between the predicted results and the measured operation results of the digital twin model is shown in FIG. 4A-FIG. 4F.

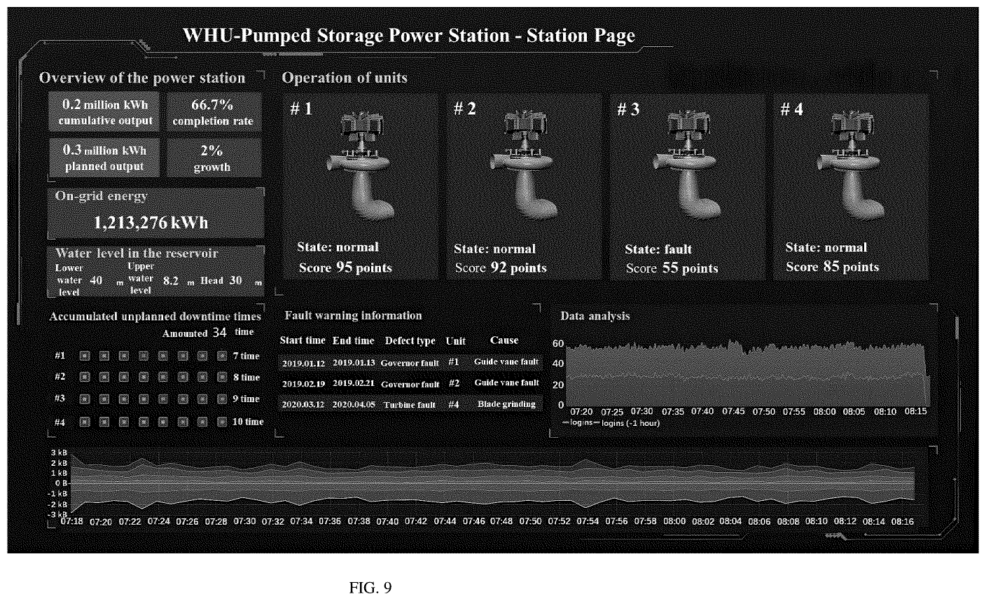

Further, the health assessment module evaluates the unit health state by using a fuzzy analytic hierarchy process and based on real-time operation data, and evaluates a potential accident process of the unit based on prediction data of the transient process, analyzes advantages and disadvantages of the transient process, and evaluates data of inversion transient process during debugging and maintenance for optimization and comparison of different control strategies. The system is characterized by adding state evaluation in transient process prediction and interactive simulation process evaluation in debugging and maintenance, and optimizing and guiding unit operation strategy. The service layer interface of health assessment is shown in FIG. 9.

Further, the fault warning module (FIG. 9) adopts a fault tree theory or an expert semantic network to establish a set of targeted fault diagnosis knowledge base, and locates the fault type and reason according to operation data. The specific function is to issue an early warning when the adjustment guarantee value exceeds the standard in the transient process prediction of the system under extreme working conditions, and an early warning signal is issued when the health assessment value is lower than the control value under normal operating conditions. Compared with the existing fault diagnosis system of pumped storage units based on data drive, the design concept of the disclosure is different, and the disclosure has the advantage of the digital twin model to predict the transient process and realizes the fault warning based on model drive.

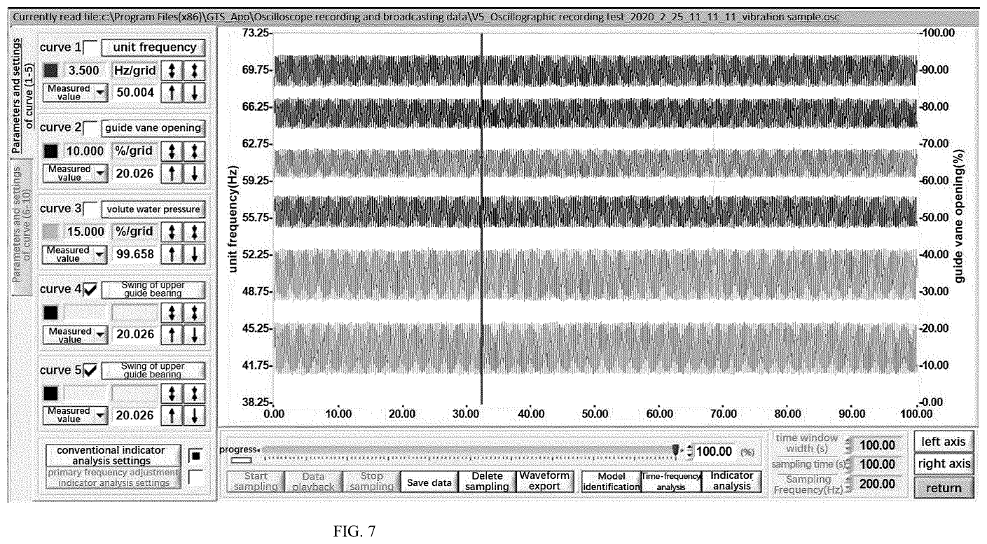

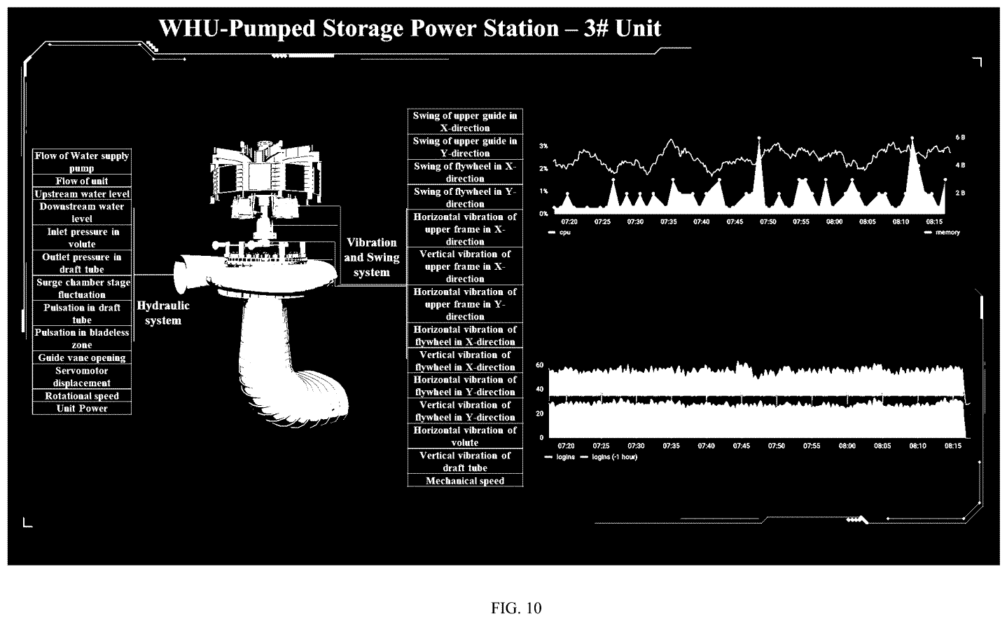

Further, the front-end visualization module directly presents the equipment of the power station system based on the three-dimensional visualization technology, marks the positions of the measuring points of the sensors, and displays the operation data in real time; the front-end visualization module is extensible, and may be incorporated into the relevant functional modules of the plant, dam and other systems in the future to realize intelligent monitoring and inversion of the whole plant. The three-dimensional display interface is shown in FIG. 10. At the same time, one-dimensional time domain parameters are displayed based on the predicted (as shown in FIG. 5) and measured operation data (as shown in FIG. 7) of the transient process.

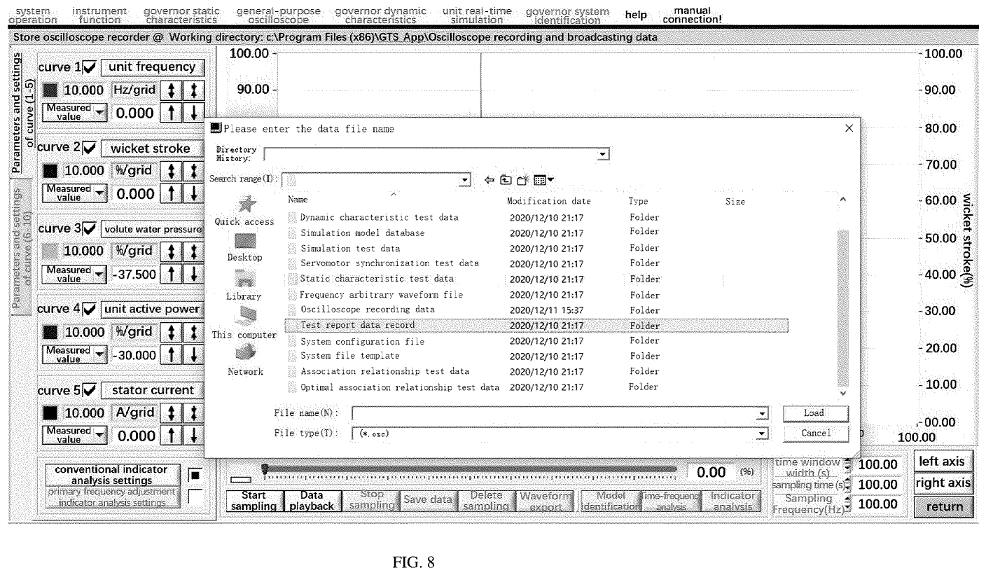

Further, the front-end visualization module also includes the interface development and front-end integration of the upper computer in the service layer, and the development of sub-interfaces such as operation optimization, online monitoring, inversion, dynamic prediction, health assessment and fault warning; when running online, real experimental instructions are sent to the console; when the off-line transient process is inverted and predicted, the virtual working condition experimental instruction is issued to the twin layer; auxiliary functions such as experimental data analysis and export, report printing, user management, etc. are provided, and the related interfaces are shown in FIG. 8.

The above-mentioned embodiment is only the preferred technical scheme of the present disclosure, and should not be regarded as the limitation of the present disclosure. The scope of protection of the present disclosure should be the technical scheme described in the claims, including the equivalent alternatives of technical features in the technical scheme described in the claims. I.e., equivalent substitution and improvement within this range, are also within the protection scope of the present disclosure.

What is claimed is:

1. An intelligent monitoring, inversion and prediction system for a transient process of pumped storage units, comprising an equipment layer, a data layer, a twin layer and a service layer; the equipment layer comprises sensors for obtaining hydraulic, mechanical and electrical operation data of the pumped storage units in real time, wherein the sensors are interconnected with real hydropower control equipment through a hard wiring mode to form closed-loop control, so as to realize an inversion; the data layer comprises a real-time database, a relational database, an expert knowledge base and a file system, the data layer is used for storing hydraulic, mechanical and electrical operation parameters collected by the equipment layer in different levels; the twin layer comprises a modeling and an application of a digital twin model, the twin layer adopts a dual-drive mode of model driven and data driven, a twin unit with the digital twin model as a core has a function of inversion with a real unit and an ability to correct and update model parameters; and the service layer is used for a three-dimensional modeling and a visual display of key information of a pumped storage system with Building Information Modeling (BIM) technology; the service layer displays one-dimensional time domain parameters based on predicted and measured operation data of a transient process of the digital twin model, and designs and visualizes front-end interfaces for six functions: operation optimization, online monitoring, inversion, dynamic prediction, health assessment and fault warning.

2. The intelligent monitoring, inversion and prediction system for the transient process of the pumped storage units according to claim 1, wherein the equipment layer also comprises data acquisition instruments, a data switch, a command console, an intelligent system terminal and a data server; wherein the data acquisition instruments comprise an unit data acquisition instrument, an electrical system data acquisition instrument and a waterway data acquisition instrument; the intelligent system terminal is electrically connected with the unit data acquisition instrument, the electrical system data acquisition instrument and the waterway data acquisition instrument through the data switch; the intelligent system terminal is electrically connected with a remote end of the command console through the command console; the intelligent system terminal is electrically connected with a remote end of the acquisition instrument; the intelligent system terminal is electrically connected with the data server; the data server is electrically connected with a supervision system; the supervision system is electrically connected with the command console and a monitoring remote end respectively.

3. The intelligent monitoring, inversion and prediction system for the transient process of the pumped storage units according to claim 2, wherein the sensors comprise a water hammer pressure sensor, a pressure pulsation sensor, a differential pressure sensor, an electromagnetic flowmeter, a main servomotor travel sensor, a ball valve servomotor travel sensor, a hydraulic turbine shaft torque sensor, an unit speed sensor, an unit vibration sensor, a spindle swing sensor, a ball valve vibration sensor and a vibration sensor of penstock.

4. The intelligent monitoring, inversion and prediction system for the transient process of the pumped storage units according to claim 2, wherein the command console has two functions: a debugging and operation condition instruction and a normal operation condition instruction, and the command console and the supervision system are in two-way communication.

5. The intelligent monitoring, inversion and prediction system for the transient process of the pumped storage units according to claim 2, wherein the supervision system triggers the command console to send an acquisition instruction to the data acquisition instruments, and forms an independent data packet for each transient process, so as to provide actual measurement, inversion analysis and early warning for the transient process; the supervision system triggers the command console to send an acquisition instruction to a data acquisition system while giving an instruction to operate related control equipment.

6. The intelligent monitoring, inversion and prediction system for the transient process of the pumped storage units according to claim 2, wherein an instruction for the data acquisition system to stop an acquisition is issued by the command console at the same time as a start instruction according to a working condition nature of the transient process, or the data acquisition instruments automatically judge fluctuations of various physical quantities, sets corresponding bandwidths, and automatically stops the acquisition.

7. The intelligent monitoring, inversion and prediction system for the transient process of the pumped storage units according to claim 2, wherein the data server comprises a data receiving server, a data processing server and a WEB server, wherein the data receiving server is used for receiving data of the acquisition system, the data processing server is used for storing and processing the data, and the WEB server is used for running an online information publishing service; the data server is used for connecting with the command console to issue instructions to each data acquisition instrument, and for summarizing collected data to form working condition data packets. The data server has a preprocessing function, a data display function and a data processing function, and the working condition data packets are stored in the data server.

8. The intelligent monitoring, inversion and prediction system for the transient process of the pumped storage units according to claim 1, wherein the twin layer comprises a processing and mining module, wherein the processing and mining module is used for data cleaning, data analysis and data mining.

9. The intelligent monitoring, inversion and prediction system for the transient process of the pumped storage units according to claim 1, wherein the twin layer comprises a digital twin module, the digital twin module is used for constructing the digital twin model of the pumped storage units and developing the digital twin function.

10. The intelligent monitoring, inversion and prediction system for the transient process of the pumped storage units according to claim 1, wherein the service layer comprises a health assessment module, a fault warning module and a front-end visualization module; wherein the health assessment module evaluates the unit health state by using a fuzzy analytic hierarchy process and based on real-time operation data, and evaluates a potential accident process of the unit based on prediction data of the transient process, analyzes advantages and disadvantages of the transient process, and evaluates data of inversion transient process during debugging and maintenance for optimization and comparison of different control strategies; wherein the fault warning module adopts a fault tree theory or an expert semantic network to establish a set of targeted fault diagnosis knowledge base, and locates the fault type and reason according to operation data; the fault warning module is used for giving an early warning when the adjustment guarantee value exceeds the standard in the transient process prediction of the system under extreme working conditions, and an early warning signal is issued when the health assessment value is lower than the control value under normal operating conditions; wherein the front-end visualization module directly presents the equipment of the power station system based on the three-dimensional visualization technology of BIM, marks the positions of the measuring points of the sensors, and displays the operation data in real time.
